(19) United States
(12) Patent Application Publication
(10) Pub. No.: US 2023/0283118 A1
(43) Pub. Date: Sep. 7, 2023

(54) Transmitting unit, energy transfer module, energy transfer system, and energy transmitting and receiving unit

(71) Applicant: Hilti Aktiengesellschaft, Schaan (LI)

(72) Inventors: Roland SCHAER, Grabs (CH); Lukas HORNSCHEIDT-SCHRITTWIESER, Dietikon (CH); Dan MUGIOIU, Dietikon (CH); Markus Christian WEGMANN, Dietikon (CH); Noah HÜSSER, Lenzburg (CH)

(21) Appl. No.: 18/014,927

(22) PCT Filed: Jul. 2, 2021
(86) PCT No.: PCT/EP2021/068391

§ 371 Date: Jan. 6, 2023

(30) Foreign Application Priority Data
Jul. 13, 2020 (EP) 20185450.2
Jul. 13, 2020 (EP) 20185484.1

(51) Int. Cl. H02J 50/40; H02J 50/80

(52) U.S. Cl. CPC H02J 50/402; H02J 50/80; H02J 50/10

(57) ABSTRACT

A transmitting unit (16) for transferring energy to a mobile device (12) for supplying the mobile device (12), in particular a handheld power tool, with energy needed to operate the mobile device (12), wherein the energy is transferred wirelessly, including an energy transfer area (26) for wirelessly transferring energy to the mobile device (12), and a communication interface (18) which is configured to communicate with a further, similar transmitting unit (16). An energy transfer module (14), to an energy transfer system (10) and to an energy transmitting and receiving unit (32).

The present invention relates to a transmitting unit for transferring energy to a mobile device, in particular a handheld power tool, for supplying the mobile device with energy needed to operate the mobile device, wherein the energy is transferred wirelessly, comprising at least one energy transfer area for wirelessly transferring energy to the mobile device.

The contents of the description, the claims and the drawing of the European patent application with file reference EP20185450 filed at the European Patent Office on Jul. 13, 2020 and now published as EP 3940920 A1, which is hereby incorporated by reference herein, form part of this description by way of express reference.

### SUMMARY OF THE INVENTION

In order to be able to operate a mobile device, for example a battery-operated handheld power tool, it is generally necessary to charge an energy store, in particular a battery, of the mobile device in advance. This is usually carried out by means of an energy transfer system, for example a charging device, which is specially tailored to the mobile device and to which the mobile device is coupled for charging.

A user often uses a plurality of mobile devices at the same time. It is therefore often also necessary to charge a plurality of energy stores of the mobile devices used at the same time or at least in a temporally overlapping manner. The user therefore previously generally required a plurality of energy transfer systems. They are in turn often supplied with energy by means of connection to the local power grid. Use of a multiplicity of energy transfer systems therefore usually results in undesirable additional outlay as a result of the construction and start-up of the energy transfer systems. Furthermore, the mobile devices must be placed and oriented at predefined positions with a relatively high degree of accuracy in order to be able to ensure that sufficient energy is transferred to the respective mobile device and, in particular in the case of wireless energy transfer systems, to avoid radiated interference in the energy transfer systems.

It is an object of the present invention to provide at least one apparatus which makes it possible for a user to transfer energy to one or more mobile devices in a particularly convenient and correct manner.

The present invention provides a transmitting unit for transferring energy to a mobile device for supplying the mobile device, in particular a handheld power tool, with energy needed to operate the mobile device, wherein the energy is transferred wirelessly, comprising an energy transfer area for wirelessly transferring energy to the mobile device, and a communication interface which is configured to communicate with a further, similar transmitting unit.

The invention is therefore based on the concept of providing transmitting units, in particular as part of an energy transfer system, which can each transfer energy to a mobile device by means of their energy transfer area and can at least communicate with one another. Therefore, the transmitting units can interchange information with one another, for example relating to parameters needed to transfer energy. If the transmitting units have one or more transmitting coils for transferring energy via the energy transfer areas, synchronization information for synchronizing the operation of the transmitting coils of different transmitting units can be interchanged. Unnecessary operation of one or more transmitting coils and therefore undesirable radiated interference can therefore be avoided. Convenience can be increased further since, even if the mobile device is placed inaccurately, for example if the mobile device is placed over a plurality of transmitting units, it is possible to transfer energy with high power to the mobile device.

Stringing together a plurality of transmitting units also makes it possible to form a particularly large total energy transfer area from the individual energy transfer areas of the individual transmitting units. If the transmitting units are preassembled in a manner strung together in this way, set-up times in situ for constructing the transmitting units or energy transfer systems needed for a multiplicity of mobile devices can be considerably shortened.

In this case, a similar transmitting unit can be understood as meaning a transmitting unit of identical construction. Alternatively or additionally, a transmitting unit which, in principle, has a structurally identical construction can also be subsumed under “similar”. In particular, it is conceivable for it to also be understood as meaning a transmitting unit which although having a number of transmitting coils which differs from a first transmitting unit, all transmitting coils are connected according to the same electrical basic principle, for example a principle of operation with phase-synchronized coil currents.

The communication interface may be configured as a wireless interface. Alternatively or additionally, it may also be in the form of a wired interface.

The transmitting unit may be configured to transfer energy with particularly high powers, for example at least 10 W, preferably at least 100 W. It may also be configured to transfer at most 5 kW, in particular at most 2 kW. It may be configured, in particular, to transfer energy to an electrical handheld power tool and/or to an electrical energy store of such an electrical handheld power tool.

The transmitting unit may have an energy supply interface or a plurality of energy supply interfaces for interchanging the electrical energy needed to operate at least one of the transmitting units with the further transmitting unit in a unidirectional or bidirectional manner. The transmitting unit may therefore be supplied with energy by the further transmitting unit or may supply the further transmitting unit with energy. One electrical energy source connected to one of the transmitting units may therefore suffice to supply at least two, generally a plurality of, transmitting units with energy.

The transmitting unit preferably has at least two energy supply interfaces. They may be arranged and/or formed on different sides of the transmitting unit. Transmitting units may therefore be strung together horizontally and/or vertically. At least one of the transmitting units may be supplied with energy by an adjacent transmitting unit. This transmitting unit may also supply another adjacent transmitting unit with energy.

The communication interface may preferably form at least one of the energy supply interfaces, with the result that both information and energy needed to operate a transmitting unit can be transferred to the further transmitting unit or obtained from the latter by means of the communication interface. If the communication interface is wireless, it may be designed to inductively transfer both the information and the energy. In the case of a wired communication interface, the information and the energy can be transferred via a common cable.

In order to transfer synchronization information, the communication interface may be configured such that at least one piece of information relating to a target phase angle of the current flowing in a transmitting coil of the transmitting unit or relating to a relative target phase angle can be transferred.

In particularly preferred embodiments, provision is made for at least two transmitting coils to be operated, in particular controlled, in such a manner that the currents flowing through them have a relative phase angle which is limited in terms of absolute value. In particular, the relative phase angle may be at most 45°, particularly preferably at most 15°. Extremely preferably, the currents of the at least two transmitting coils are in phase with one another or are at least substantially in phase with one another. A method for controlling the transmitting coils can therefore be configured to minimize the relative phase angle. The at least two transmitting coils may belong to the same transmitting unit or to different transmitting units. In the latter case in particular, the relative phase angle can be controlled with the aid of the synchronization information which can be transferred via the communication interface.

In a particularly advantageous category of embodiments of the invention, the transmitting unit can be connected to the further transmitting unit in a force-fitting and/or form-fitting manner, with the result that a plurality of transmitting units can be strung together in a particularly simple manner. The force fit and/or form fit may be formed on one or more sides of the transmitting unit. The transmitting unit may have a latching mechanism for this purpose. Alternatively or additionally, it may also have magnetic, in particular permanent magnetic, regions. Particularly preferably, the transmitting unit and the further transmitting unit may be connected to one another without tools.

The present disclosure also provides an energy transfer module for transferring energy to a mobile device for supplying energy needed to operate the mobile device (12), in particular a handheld power tool, in which the energy is transferred wirelessly and which comprises a transmitting unit according to the invention and an electrical energy source. The energy transfer module may therefore be a special transmitting unit which has an energy source. It is therefore conceivable for the energy transfer module and/or further transmitting units to be supplied with energy by this electrical energy source.

The electrical energy source may preferably have a grid current input or a rechargeable or non-rechargeable energy store. In particular, the electrical energy source may have a battery or a fuel cell.

The invention also includes an energy transfer system which comprises an energy transfer module according to the invention and a transmitting unit according to the invention and can therefore inherently provide a particularly large total energy transfer area.

The invention also provides an energy transmitting and receiving unit which comprises a transmitting unit according to the invention and a mobile device which is configured to wirelessly receive energy from the transmitting unit. In this case, it is conceivable for the transmitting unit to be in the form of an energy transfer module.

The transmitting unit may have at least two transmitting coils. They may be configured to transfer energy via the energy transfer area of the transmitting unit. The mobile device may have at least one receiving coil. In this case, the receiving coil may be larger than at least one of the transmitting coils. The receiving coil may therefore span a plurality of the transmitting coils.

Further features and advantages of the invention emerge from the following detailed description of exemplary embodiments of the invention, with reference to the figures of the drawing, which shows details essential to the invention, from the claims and from the description and the figures of the drawing of the European patent application which was mentioned at the beginning and has been incorporated by reference.

The features shown there are not necessarily to be understood as true to scale and are shown in such a way that the special features according to the invention can be made clearly visible. The various features can be implemented individually in their own right or collectively in any combination in variants of the invention.

In the schematic drawing, exemplary embodiments of the invention are shown and explained in more detail in the following description.

### BRIEF DESCRIPTION OF THE DRAWINGS

FIG. 1 shows a schematic illustration of an energy transmitting and receiving unit, and

FIG. 2 shows a schematic illustration of a further energy transmitting and receiving unit.

### DETAILED DESCRIPTION

In order to make it easier to understand the invention, the same reference signs are used in each case for identical or functionally corresponding elements in the following description of the figures. In addition, if possible, continued use is made of the reference signs used in the above-mentioned European patent application incorporated by reference.

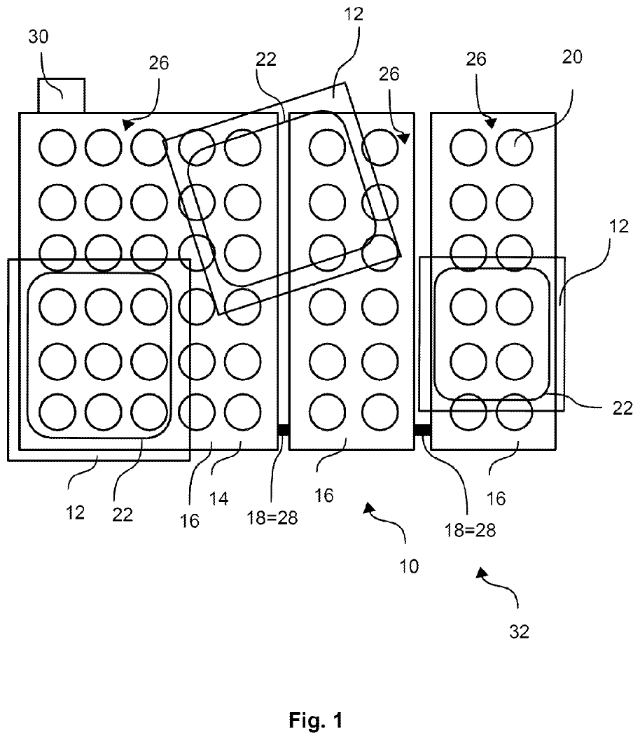

FIG. 1 shows an energy transmitting and receiving unit 32 comprising an energy transfer system 10 and a plurality of, three by way of example in FIG. 1, mobile devices 12. In particular, energy stores of the mobile devices 12 are intended to be charged by means of the energy transfer system 10. The mobile devices 12 can be, for example, battery-operated hammer drills, chiseling machines, drilling machines or other battery-operated handheld power tools or a battery block for such a handheld power tool.

The energy transfer system 10 has an energy transfer module 14 as well as two further transmitting units 16. The transmitting units 16 are coupled to the energy transfer module 14 via communication interfaces 18.

The energy transfer module 14 likewise has a transmitting unit 16. Its transmitting unit 16 and the two other transmitting units 16 all have a similar construction.

Furthermore, the energy transfer module 14 has an electrical energy source 30. The electrical energy source 30 is, in particular, in the form of a grid connection, with the result that the energy transfer module 14 and—as explained in more detail further below—therefore also the energy transmitting and receiving unit 32 can be supplied overall with energy with electrical energy needed for operation from a power grid which is not illustrated in FIG. 1.

The communication interfaces 18 have electrical connection elements, in particular plug connectors and sockets of complementary design. The communication interfaces 18 at the same time form energy supply interfaces 28. The transmitting units 16 can therefore interchange electrical energy needed to operate at least one of the transmitting units 16 in a bidirectional manner via the communication interfaces 18. In particular, a feed current can respectively flow via the communication interfaces 18. In this manner, the other transmitting units 16 are supplied with the electrical energy needed for operation by the energy transfer module 14 and, in particular, its electrical energy source 30.

In addition, a piece of information relating to a target phase angle can be transferred from the energy transfer module 14 to the respective transmitting unit 16 via the communication interfaces 18. For this purpose, the communication interfaces 18 are configured to communicate with respectively similar transmitting units 16. In particular, a respective target phase angle can be coded by a phase angle of the feed current. For example, a phase angle of the feed current can correspond to the target phase angle to be set or to be achieved in each case.

The energy transfer module 14 and the transmitting units 16 each have a plurality of transmitting coils 20, only one transmitting coil 20 of which is marked with a reference sign in order to simplify the illustration. The transmitting coils 20 are each distributed in a flat, in particular matrix-like, manner in the energy transfer module 14 or in the respective transmitting units 16. They therefore form energy transfer areas 26 for wirelessly transferring energy to the mobile devices 12.

The mobile devices 12 are configured in particular for electromagnetic, in particular inductive, coupling to the energy transfer system 10. The mobile devices 12 each have a receiving coil 22. The receiving coils 22 are configured to receive energy emitted by at least one of the transmitting coils 20, provided that they are located in a respective spatial energy transfer area of the respective transmitting coil 20.

The transmitting units 16, including the transmitting unit 16 of the energy transfer module 14, are connected according to the same electrical basic principle. It is conceivable for the number of transmitting coils 20 of the transmitting units 16 to differ. FIG. 1 illustrates, by way of example, that the transmitting unit 16 of the energy transfer module 14 has more transmitting coils 20 than the other transmitting units 16.

The transmitting unit 16 arranged in the center according to FIG. 1 has, by way of example, two communication interfaces 18 and therefore two energy supply interfaces 28, whereas the energy supply module 14 or its transmitting unit 16 and the transmitting unit 16 arranged on the right in FIG. 1 each have only one of the interfaces 18, 28.

Further features, for example the electrical connection of the different components, can be gathered from the above-mentioned European patent application incorporated by reference.

It can be seen that the mobile devices 12 are freely placed and freely oriented on the energy transfer system 10, in particular for energy transfer.

It can also be seen that the receiving coils 22 each span a larger area than one of the transmitting coils 20 in each case. In other words, the receiving coils 22 are larger than the transmitting coils 20. In particular, the receiving coils 22 are larger than the respective spatial energy transfer areas of the respective transmitting coils 20. For example, the mobile device 12 placed furthest to the left in FIG. 1 and in particular its receiving coil 22 span nine transmitting coils 20.

The energy transfer system 10 has a modular structure. Further transmitting units 16 (not illustrated in FIG. 1) and preferably further energy transfer modules (also not illustrated in FIG. 1) can be connected to the energy transfer module 14 by means of the communication interface 18, with the result that the energy transfer system 10 and in particular the energy transfer area of the energy transfer system 10 are enlarged. One or both of the other transmitting units 16 can also be decoupled, in particular from the communication interface 18, with the result that the energy transfer system 10 and in particular its energy transfer area are reduced.

The energy transfer system 10, in particular its energy transfer module 14, has—not illustrated in FIG. 1 in each case—a programmable control unit with a memory unit, in which program code is stored in an executable manner, and with electrical switching elements controllable by means of program code. The control unit is configured in particular to control the transmitting coils 20 in accordance with the method according to the invention. It is conceivable that, as an alternative or in addition, the transmitting units 16 each have their own correspondingly configured control units for controlling their respective transmitting coils 20.

In this respect too, further features are found in the European patent application incorporated by reference.

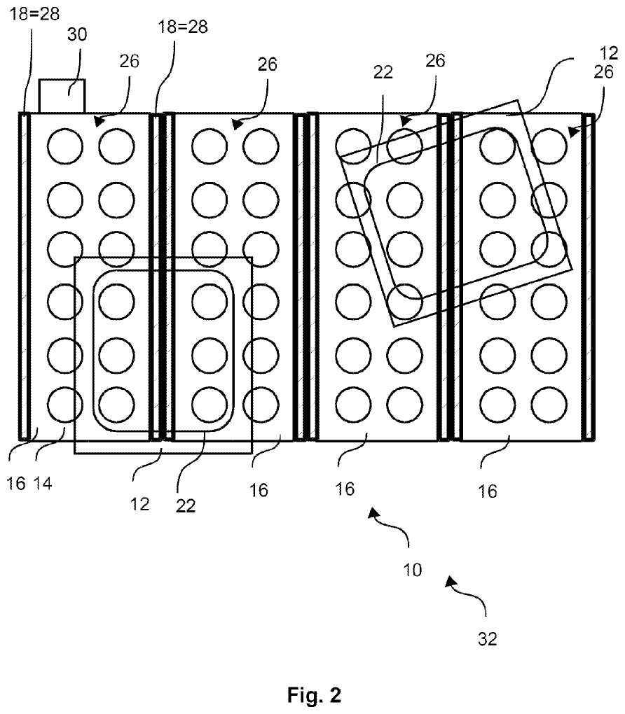

FIG. 2 shows a further energy transmitting and receiving unit 32 which, insofar as not described otherwise below, is designed in a similar manner to the energy transmitting and receiving unit 32 which is depicted in FIG. 1 and was described above, with the result that the special features of this exemplary embodiment are primarily explained below.

The energy transmitting and receiving unit 32 in turn has an energy transfer system 10 having an energy transfer module 14, which has a transmitting unit 16 and an electrical energy source 30, and having a plurality of further transmitting units 16 as well as two mobile devices 12 by way of example here.

One of the special features is that all transmitting units 16, preferably including the transmitting unit 16 of the energy transfer module 14, each have at least two communication interfaces 18. The communication interfaces 18 are again at the same time energy supply interfaces 28. In this case, only the two communication interfaces 18 and the two energy supply interfaces 28 of the transmitting unit 16 arranged furthest to the left in FIG. 2, that is to say of the transmitting unit 16 of the energy supply module 14, are representatively provided with reference signs in FIG. 2 for the purpose of simplifying the illustration.

The communication interfaces 18 and preferably also the energy supply interfaces 28 are wireless, in particular are in the form of inductive interfaces. The communication interfaces 18 are preferably considerably narrower than the energy transfer areas 26 of the respective transmitting units 16.

They are respectively formed on two longitudinal sides of the transmitting units 16. In addition, they at least partially have permanent magnetic properties. Two transmitting units 16 can therefore be respectively connected to one another in a force-fitting manner by approaching one another. On account of mutual magnetic attraction of the transmitting units 16, they can also be automatically aligned and positioned with respect to one another along their respective longitudinal sides.

On account of the inductive transfer of information and the energy needed to operate the transmitting units 16, there is no need to manually plug or connect one transmitting unit 16 to another.

The energy transfer system 10 and therefore its total energy transfer area can therefore be adapted, in particular in a modular manner, by simply laterally stringing together transmitting units 16, as required.

1-11. (canceled)

12. A transmitting unit for transferring energy to a handheld power tool for supplying the a handheld power tool with energy needed to operate the handheld power tool, wherein the energy is transferred wirelessly, the transmitting unit comprising:
an energy transfer area for wirelessly transferring energy to the handheld power tool; and
a communication interface configured to communicate with a further, similar transmitting unit.

13. The transmitting unit as recited in claim 12 further comprising at least one energy supply interface for interchanging the electrical energy needed to operate at least one of the transmitting units with the further transmitting unit in a unidirectional or bidirectional manner.

14. The transmitting unit as recited in claim 13 wherein the at least one energy supply interface includes at least two energy supply interfaces.

15. The transmitting unit as recited in claim 14 wherein the communication interface forms at least one of the energy supply interfaces.

16. The transmitting unit as recited in claim 13 wherein the communication interface is configured as a wireless interface.

17. The transmitting unit as recited in claim 13 wherein the communication interface is configured such that at least one piece of information relating to a target phase angle of the current flowing in a transmitting coil of the transmitting unit or relating to a relative target phase angle is transferable.

18. The transmitting unit as recited in claim 13 wherein the transmitting unit is connectable to the further transmitting unit in a force-fitting or form-fitting manner.

19. An energy transfer module for transferring energy to a handheld power tool for supplying energy needed to operate the handheld power tool, wherein the energy is transferred wirelessly, the energy transfer module comprising:
the transmitting unit as recited in claim 13; and
an electrical energy source.

20. The energy transfer system as recited in claim 20 further comprising the further transmitting unit.

21. An energy transmitting and receiving unit comprising the transmitting unit as recited in claim 13 and the handheld power tool.

22. The energy transmitting and receiving unit as recited in claim 21 wherein the transmitting unit has at least two transmitting coils and the handheld power tool has at least one receiving coil, wherein the receiving coil is larger than at least one of the transmitting coils.
